(19) United States
(12) Patent Application Publication
(10) Pub. No.: US 2020/0141464 A1
(43) Pub. Date: May 7, 2020

(54) CONTROL DEVICE

(71) Applicant: DTECH PRECISION INDUSTRIES CO., LTD., NEW TAIPEI CITY (TW)

(72) Inventor: TING-JUI WANG, NEW TAIPEI CITY (TW)

(21) Appl. No.: 16/665,251

(22) Filed: Oct. 28, 2019

(30) Foreign Application Priority Data
Nov. 1, 2018 (TW) 107138859

(51) Int. Cl. F16F 1/12; F16F 1/02; F16F 1/46

(52) U.S. Cl. CPC F16F 1/123; F16F 1/46; F16F 1/024

(57) ABSTRACT

A control device includes a head portion and a body portion. The body portion is movably fitted to the head portion. Lateral buoyancy level, vertical buoyancy level or rotational buoyancy level between the head portion and the body portion enables the shifting, tightening, restrictive abutment or rotational abutment between the head portion and the body portion. Therefore, the body portion of the control device is fitted to a body portion of a first object, and the head portion of the control device engages or removes a second object, so as to achieve the coupling and separating of the first and second objects. Hence, the control device can couple together and separate the first and second objects repeatedly and rapidly.

### CROSS-REFERENCE TO RELATED APPLICATION

This non-provisional application claims priority under 35 U.S.C. § 119(a) on Patent Application No(s). 107138859 filed in Taiwan, R.O.C. on Nov. 1, 2018, the entire contents of which are hereby incorporated by reference.

### BACKGROUND OF THE INVENTION

### 1. Field of the Invention

The present disclosure relates to control devices, and in particular to a control device capable of being coupled to and separated from at least one object repeatedly and rapidly.

### 2. Description of the Related Art

A conventional means to couple at least one object to a device entails fastening the at least one object and the device together by screws.

Although the conventional means manages to couple the at least one object to the device in an inseparable manner, it is not only inefficient but also disadvantaged by screw-induced difficulty in demounting the at least one object.

### BRIEF SUMMARY OF THE INVENTION

At least one embodiment of the present disclosure provides a control device. The body portion of the control device can be fitted to a body portion of a first object. The head portion of the control device engages or removes a second object. Hence, the control device can couple together two objects and separate the two objects, performing the coupling and separating processes repeatedly and rapidly.

The present disclosure provides a control device which comprises a head portion and a body portion. The body portion is movably fitted to the head portion. Lateral buoyancy level, vertical buoyancy level or rotational buoyancy level between the head portion and the body portion enables shifting, tightening, restrictive abutment or rotational abutment between the head portion and the body portion.

Preferably, the body portion has a fitting portion fitted to the first object.

Preferably, the lateral buoyancy level, vertical buoyancy level or rotational buoyancy level ranges from 0.01 mm to 500 mm.

Preferably, a resilient component is disposed between the head portion and the body portion and adapted to abut against the head portion or the body portion and thereby cause the head portion or the body portion to undergo a lateral, vertical or rotational movement, or a restoring movement performed after motion and intended to restore to a pre-motion position.

Preferably, the head portion has a head-shaped portion or an axial portion such that the head-shaped portion or the axial portion is movably fitted to the body portion.

Preferably, the head-shaped portion has a variable portion and thereby is deformable under an applied force such that the head-shaped portion movably restricts movement of, abuts against and is fitted to a corresponding structure of the body portion.

Preferably, the body portion has a variable portion deformable under an applied force to therefore abut against and restrict movement of a corresponding structure of the axial portion or a corresponding structure of the head-shaped portion so as to be movably fitted to the head portion.

Preferably, the resilient component laterally, vertically, or rotationally abuts against the head portion or the body portion.

Preferably, the head portion or the body portion has therein a receiving space for receiving the resilient component.

Preferably, the head portion has a guiding portion for guiding the second object to become disposed between the head portion and the body portion by engagement or snap-engagement and thereby movement-restricted, or to be movement-restricted by the head portion.

Preferably, the head portion is a raised element, dented element, outer engaging element, hook engaging element, thread element, cylindrical element, inner engaging element or disk-shaped element.

Preferably, the axial portion comprises the resilient component and the head portion.

Preferably, the fitting portion is riveted to, engaged with, fastened to, expanded to, welded to or interfered and fitted to the first object, or rested on or placed on and connected to the first object.

Preferably, the variable portion of the body portion is an upward-protruding element or a downward-protruding element with a hole portion such that, as soon as a corresponding structure of the axial portion passes through the hole portion and thus is subjected to pressure under an applied force, the hole portion of the variable portion is smaller than the corresponding structure of the axial portion, thereby allowing the body portion to be movably fitted to the head portion.

Preferably, the head portion is a resilient engaging element capable of resilient engagement and adapted to abut against a corresponding structure of the body portion, then expand, and finally engage with the corresponding structure of the body portion.

Preferably, the fitting portion has a material-storing space such that, as soon as the body portion presses against the first object, material of the first object is subjected to pressure and thus enters or flows into the material-storing space, thereby allowing the body portion to be fitted to the first object.

Preferably, the fitting portion is subjected to compression under an applied force and thus deforms and engages with the first object, thereby allowing the body portion to be fitted to the first object.

Preferably, the fitting portion has a weldable surface adapted to be placed on the surface of the first object and then heated up such that the body portion can be welded to the first object.

Preferably, the control device is carried by a carrier and taken out of the carrier with a tool before being placed on the first object, so as to fit the control device to the first object.

Preferably, the axial portion has an engaging portion, and the engaging portion is a cylindrical element, thread element, outer engaging element, inner engaging element, resilient engaging element, raised engaging element, hook element, dented element or raised element.

Preferably, the resilient component is a spring, torsional spring, helical spring, leaf spring, resilient cylindrical element or resilient engaging element.

Preferably, the axial portion is a cylindrical element, raised element, dented element, hole element, slot element, fitting element, engaging element or resilient element.

Preferably, the head portion has a pulling portion for pulling the control device.

Preferably, the head portion has a through hole or a slot portion conducive to positioning the pulling portion in place.

Preferably, the head portion has an operating portion for facilitating operation of another tool.

Preferably, the body portion has a rotation-preventing portion or a limiting portion, and the head portion has a corresponding rotation-preventing portion or a corresponding limiting portion, to prevent or restrict rotation and movement relative to each other.

Preferably, the body portion and the head portion are pivotally connected and fitted to each other by a pivotally connecting portion.

Preferably, the body portion has a limiting portion, whereas the head portion has an axial portion or a cap portion, and the axial portion or the cap portion has a corresponding limiting portion for restricting rotational buoyancy displacement of the head portion.

Preferably, forward or lateral rotational buoyancy displacement occurs between the body portion and the head portion.

Preferably, the control device further comprises a torsional spring with two ends abutting against or twisting the head portion and the body portion, respectively, such that the head portion is capable of resilient reversing or resilient restoring or stays at an abutted position as a result of the torsional spring normally abutting against the head portion.

Preferably, the engaging portion is fitted to the third object.

Preferably, the body portion or the head portion is made of metallic material, non-metallic material or plastic material, or a rustproof layer is disposed on the surface of the body portion or the head portion.

Preferably, the head portion or the body portion has a restricting portion for restricting lateral buoyancy level, vertical buoyancy level or rotational buoyancy level of the head portion.

Preferably, the head-shaped portion and the axial portion are pivotally connected.

Preferably, the head-shaped portion and the axial portion are movably pivotally connected and fitted to each other by a pivotal connecting element, and the pivotal connecting element is a cylindrical element or engaging element and is integrally formed with the head-shaped portion or the axial portion.

Preferably, the head-shaped portion is a raised element, dented element, planar element, cylindrical element, rod element, lever element, arcuate element, curved element, stepped element, slope element, cap element, engaging element, thread element, outer engaging element, inner engaging element or resilient engaging element.

Preferably, the rotational buoyancy level is defined as a variation in an angle between the head portion and the body portion to thereby vary a distance between different positions thereof.

Preferably, the distance resulting from the angular variation equals a difference in the distance variation between different parts of the head portion or equals a difference in the distance variation between different parts of the head portion and different parts of the body portion.

Preferably, the angular variation ranges from 0.01 degree to 315 degrees.

Preferably, the body portion or the head portion is manufactured by milling, forging, rolling, stamping or injection molding.

Preferably, the body portion has a limiting portion, and the head portion has a corresponding limiting portion, such that the limiting portion and the corresponding limiting portion stop each other and thereby prevent each other from moving relative to each other.

Preferably, a resilient component is disposed between the limiting portion and the corresponding limiting portion and adapted to abut against and thereby cause the head portion or the body portion to undergo a lateral, vertical or rotational movement, or a restoring movement performed after motion and intended to restore to a pre-motion position.

Preferably, the head portion movably or non-movably engages with, is engaged with, interferes with or is stopped at the second object.

Preferably, the control device is configured to be carried by a carrier and taken out of the carrier with a tool, and a comparison device figures out an assembling location of the control device at the first object, the tool places the control device at the first object, so as to fit the control device to the first object.

Preferably, the axial portion is a cylindrical element, raised element, dented element, hole element, slot element, fitting element, engaging element or resilient element.

Preferably, a rustproof layer is disposed on the surface of the body portion or the head portion, the rustproof layer is configured to be formed by placing the head portion or the body portion in an electroplating chamber, and passing electric current to an electroplating solution in the electroplating chamber such that the head portion or the body portion is covered with a rustproof substance through the electroplating solution to form the rustproof layer.

### BRIEF DESCRIPTION OF THE DRAWINGS

To explain the embodiments of the present disclosure and the prior art clearly, the accompanying drawings are hereunder briefly described. Obviously, the accompanying drawings are merely related to some of the embodiments of the present disclosure. Persons skilled in the art are able to infer, without making any creative effort, some more accompanying drawings based on the aforesaid accompanying drawings.

FIG. 1 is a schematic view of separated state according to the 1st embodiment of the present disclosure.

FIG. 2 is a schematic view of assembled state according to the 1st embodiment of the present disclosure.

FIG. 3 is a schematic view of usage state according to the 1st embodiment of the present disclosure.

FIG. 4 is a schematic view of the resilient component of different shapes according to the present disclosure.

FIG. 5 is a schematic view of usage state according to the 2nd embodiment of the present disclosure.

FIG. 6 is a schematic view of usage state according to the 3rd embodiment of the present disclosure.

FIG. 7 is a schematic view of assembled state according to the 4th embodiment of the present disclosure.

FIG. 8 is a schematic view of assembled state according to the 5th embodiment of the present disclosure.

FIG. 9 is a schematic view of usage state according to the 6th embodiment of the present disclosure.

FIG. 10 is a cross-sectional view according to the 7th embodiment of the present disclosure.

FIG. 11 is a schematic view of assembled state according to the 8th embodiment of the present disclosure.

FIG. 12 is a schematic view of usage state according to the 8th embodiment of the present disclosure.

FIG. 13 is a schematic view 1 of usage state 1 according to the 9th embodiment of the present disclosure.

FIG. 14 is a schematic view 2 of usage state 2 according to the 9th embodiment of the present disclosure.

FIG. 15 is a schematic view 1 of usage state 1 according to the 10th embodiment of the present disclosure.

FIG. 16 is a schematic view 2 of usage state 2 according to the 10th embodiment of the present disclosure.

FIG. 17 is a cross-sectional view according to the 11th embodiment of the present disclosure.

FIG. 18 is a schematic view of usage state according to the 12th embodiment of the present disclosure.

FIG. 19 is a schematic view of usage state according to the 13th embodiment of the present disclosure.

FIG. 20 is a cross-sectional view according to the 14th embodiment of the present disclosure.

FIG. 21 is a schematic view of assembled state according to the 15th embodiment of the present disclosure.

FIG. 22 is a schematic view of usage state according to the 15th embodiment of the present disclosure.

FIG. 23 is a schematic view of the engaging portion of different shapes according to the present disclosure.

FIG. 24 is a schematic view of assembled state according to the 16th embodiment of the present disclosure.

FIG. 25 is a schematic view of usage state according to the 16th embodiment of the present disclosure.

FIG. 26 is a schematic view of assembled state according to the 17th embodiment of the present disclosure.

FIG. 27 is a schematic view of assembled state according to the 18th embodiment of the present disclosure.

FIG. 28 is a schematic view of storage and access state of the present disclosure.

FIG. 29 is a schematic view 1 of access state of the present disclosure.

FIG. 30 is a perspective view according to the 19th embodiment of the present disclosure.

FIG. 31 is a cross-sectional view according to the 19th embodiment of the present disclosure.

FIG. 32 is a schematic view according to the 20th embodiment of the present disclosure.

FIG. 33 is a top view according to the 20th embodiment of the present disclosure.

FIG. 34 is a schematic view of usage state according to the 21st embodiment of the present disclosure.

FIG. 35 is a schematic view of usage state according to the 22nd embodiment of the present disclosure.

FIG. 36 is a cross-sectional view according to the 23rd embodiment of the present disclosure.

FIG. 37 is a cross-sectional view according to the 24th embodiment of the present disclosure.

FIG. 38 is a top view according to the 24th embodiment of the present disclosure.

FIG. 39 is a top view according to the 25th embodiment of the present disclosure.

FIG. 40 is a cross-sectional view according to the 26th embodiment of the present disclosure.

FIG. 41 is a schematic view 1 of usage state 1 according to the 27th embodiment of the present disclosure.

FIG. 42 is a schematic view 2 of usage state 2 according to the 27th embodiment of the present disclosure.

FIG. 43 is a schematic view of assembled state according to the 27th embodiment of the present disclosure.

FIG. 44 is a schematic view of usage state according to the 28th embodiment of the present disclosure.

FIG. 45 is a schematic view of usage state according to the 29th embodiment of the present disclosure.

FIG. 46 is a schematic view of assembled state according to the 30th embodiment of the present disclosure.

FIG. 47 is a schematic view of an electroplated rustproof layer of the present disclosure.

FIG. 48 is a schematic view 2 of an electroplated rustproof layer 2 of the present disclosure.

FIG. 49 is a schematic view 3 of an electroplated rustproof layer 3 of the present disclosure.

FIG. 50 is a perspective view according to the 31st embodiment of the present disclosure.

FIG. 51 is a cross-sectional view according to the 31st embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

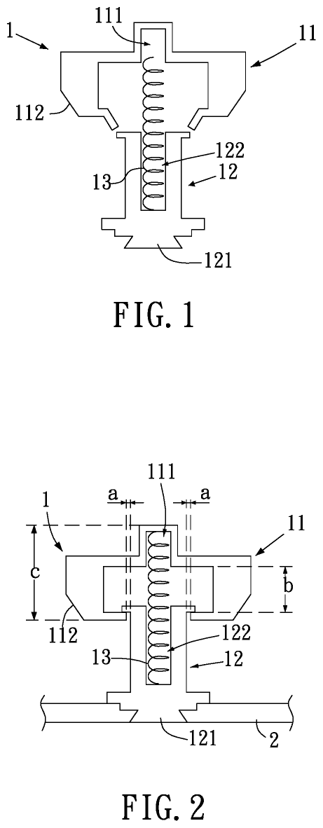

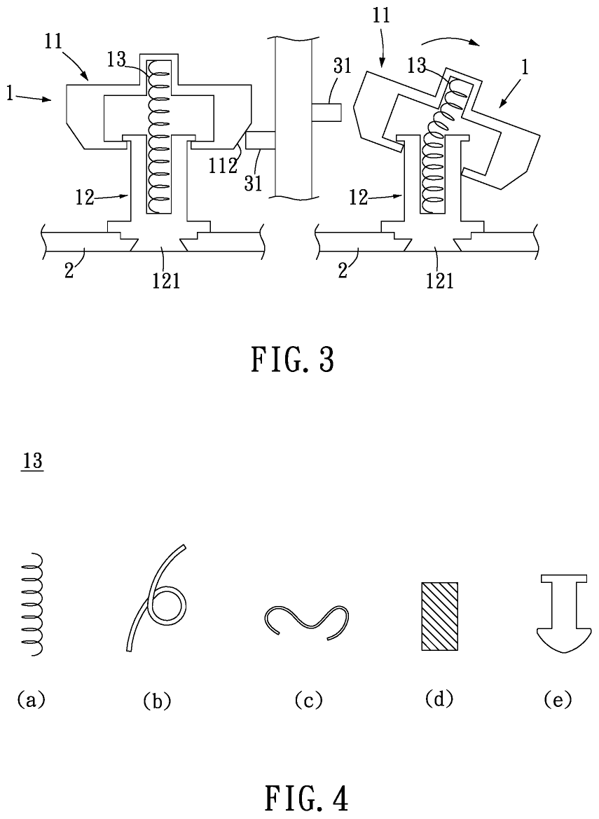

Referring to FIG. 1 through FIG. 4, the present disclosure provides a control device 1 comprising a head portion 11 and at least one body portion 12.

The body portion 12 is movably fitted to the head portion 11. Lateral buoyancy level a, vertical buoyancy level b or rotational buoyancy level c between the head portion 11 and the body portion 12 enables the shifting, tightening, restrictive abutment or rotational abutment between the head portion 11 and the body portion 12.

In an embodiment of the present disclosure, the body portion 12 has a fitting portion 121 fitted to a first object 2. The first object 2 is a printed circuit board (PCB), casing, metallic board, plastic board or case.

In an embodiment of the present disclosure, not only is a resilient component 13 disposed between the head portion 11 and the body portion 12 and adapted to vertically abut against the head portion 11 and the body portion 12, but the head portion 11 and the body portion 12 also have therein receiving spaces 111, 122, respectively, with the receiving spaces 111, 122 adapted to receive the resilient component 13. Hence, the resilient component 13 abuts against the head portion 11 and the body portion 12 and thereby causes the head portion 11 and the body portion 12 to undergo a lateral, vertical or rotational movement, or a restoring movement performed after motion and intended to restore to a pre-motion position. In a variant embodiment, the resilient component 13 rotatably abuts against the head portion 11 or the body portion 12 (not shown).

Operation of the control device 1 is described below. After the fitting portion 121 of the body portion 12 has been fitted to the first object 2, a second object 3 is disposed between the head portion 11 and the body portion 12 by engagement or snap-engagement and thereby movement-restricted. Upon engagement or snap-engagement of the second object 3, an engaging element 31 of the second object 3 exerts a lateral, vertical or rotational force on the head portion 11 such that the head portion 11 undergoes displacement because of its lateral buoyancy level a, vertical buoyancy level b or rotational buoyancy level c relative to the body portion 12; meanwhile, the resilient component 13 pushes the head portion 11 and the body portion 12 such that not only do the head portion 11 and the body portion 12 undergo lateral, vertical or rotational movement to allow the engaging element 31 of the second object 3 to become disposed between and confined to between the head portion 11 and the body portion 12 by engagement or snap-engagement, but the resilient component 13 also drives the head portion 11 to restore to its initial position, thereby coupling the first object 2 and the second object 3 together repeatedly and rapidly.

The second object 3 is a printed circuit board (PCB), casing, metallic board, plastic board or case.

Removal of the second object 3 entails exerting a lateral, vertical or rotational force on the head portion 11 such that not only does the head portion 11 undergo displacement because of its lateral buoyancy level a, vertical buoyancy level b or rotational buoyancy level c relative to the body portion 12, but the resilient component 13 also pushes the head portion 11 and the body portion 12 such that the head portion 11 and the body portion 12 undergo lateral, vertical or rotational movement to thereby allow the engaging element 31 of the second object 3 to leave the head portion 11 and the body portion 12 from between, so as to not only separate the first object 2 and the second object 3 but also cause the resilient component 13 to drive the head portion 11 to restore to its initial position, so as to effect the next instance of coupling, thereby attaining the coupling and separating repeatedly and rapidly.

The head portion 11 movably or non-movably engages with, is engaged with, interferes with or is stopped at the second object 3.

In an embodiment of the present disclosure, the head portion 11 has a guiding portion 112 for guiding the engaging element of the second object 3 to become disposed between and thereby confined to between the head portion 11 and the body portion 12 by engagement or snap-engagement, or guiding the engaging element 31 of the second object 3 to be movement-restricted by the head portion 11. Therefore, the present disclosure meets the requirement for engagement in various forms.

In an embodiment of the present disclosure, the head portion 11 is a raised element, dented element, outer engaging element, hook engaging element, thread element, cylindrical element, inner engaging element or disk-shaped element. Therefore, the head portion 11 meets the requirement for usage in various forms.

In an embodiment of the present disclosure, the fitting portion 121 is riveted to, engaged with, fastened to, expanded to, welded to or interfered and fitted to the first object 2, or rested on or placed on and connected to the first object 2. Therefore, the body portion 12 is firmly fitted to the first object 2 as needed.

In an embodiment of the present disclosure, the lateral buoyancy level a, vertical buoyancy level b or rotational buoyancy level c ranges from 0.01 mm to 500 mm. Therefore, the range of movement of the head portion 11 is optimized to facilitate engagement of the head portion 11 and the second object 2. The rotational buoyancy level is defined as a variation in the angle (hereinafter referred to as the “angular variation”) between the head portion 11 and the body portion 12 to thereby vary the distance between different positions thereof. The distance which results from the angular variation equals a difference in the distance variation between different parts of the head portion 11 or equals a difference in the distance variation between different parts of the head portion 11 and different parts of the body portion 12. The angular variation ranges from 0.01 degree to 315 degrees.

In an embodiment of the present disclosure, as shown in FIG. 4, the resilient component 13 is a spring, a helical spring (part a as shown in FIG. 4), a torsional spring (part b as shown in FIG. 4), a leaf spring (part c as shown in FIG. 4), a resilient cylindrical element (part d as shown in FIG. 4) or a resilient engaging element (part e as shown in FIG. 4). Therefore, the resilient component 13 meets the need for high industrial applicability.

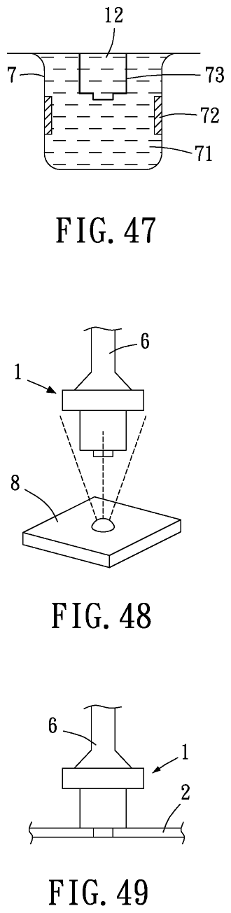

In an embodiment of the present disclosure, as shown in FIG. 47, the body portion 12 or the head portion 11 is made of metallic material, non-metallic material or plastic material, or a rustproof layer 73 (not shown) is disposed on the surface of the body portion 12 or the head portion 11. The rustproof layer 73 is formed on the surface of the body portion 12 or the head portion 11 by placing the head portion 11 or the body portion 12 in an electroplating chamber 7, and passing electric current to an electroplating solution 71 in the electroplating chamber 7 such that the head portion 11 or the body portion 12 is covered with a rustproof substance 72 through the electroplating solution 71 to form the rustproof layer 73, thereby attaining rustproofing. The rustproof substance is made of zinc, nickel, tin, chromium or copper. The body portion 12 or the head portion 11 is manufactured by milling, forging, rolling, stamping or injection molding. Therefore, the body portion 12 and the head portion 11 meet the need for high industrial applicability.

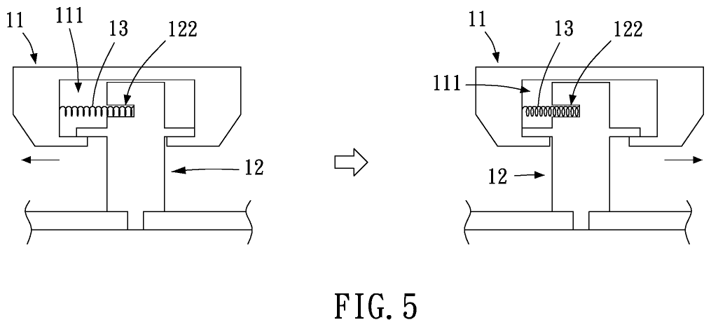

Referring to FIG. 5, in this embodiment, the resilient component 13 is laterally disposed in the receiving spaces 111, 122 of the head portion 11 and the body portion 12 to allow one end of the resilient component 13 to abut against the head portion 11 and the other end of the resilient component 13 to abut against the body portion 12. Therefore, the head portion 11 undergoes displacement because of its lateral buoyancy level a or rotational buoyancy level c relative to the body portion 12, so as to achieve the required engagement.

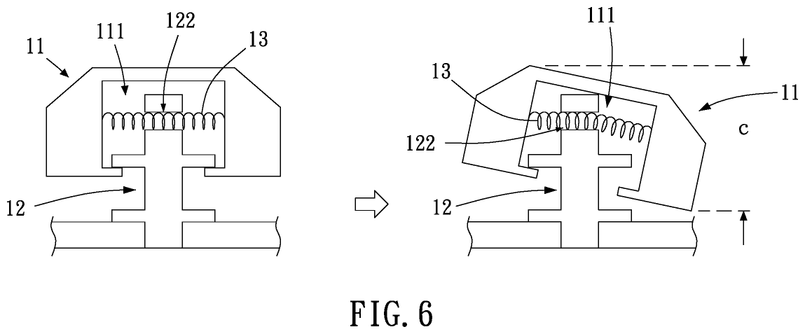

Referring to FIG. 6, in this embodiment, the resilient component 13 is laterally disposed in the receiving spaces 111, 122 of the head portion 11 and the body portion 12, whereas the resilient component 13 penetrates the receiving space 122 of the body portion 12 such that two ends of the resilient component 13 abut against the head portion 11. Therefore, the head portion 11 undergoes displacement because of its rotational buoyancy level c relative to the body portion 12, so as to achieve the required engagement.

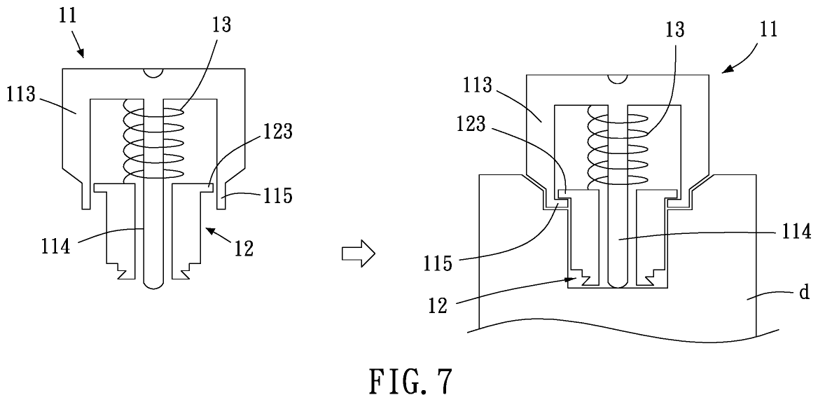

Referring to FIG. 7, in this embodiment, the head portion 11 has a head-shaped portion 113 and an axial portion 114. The head-shaped portion 113 and the axial portion 114 are movably fitted to the body portion 12. The resilient component 13 fits around the axial portion 114. Two ends of the resilient component 13 abut against the head portion 11 and the body portion 12, respectively. The head-shaped portion 113 has a variable portion 115 which a tool d abuts against and presses against such that the head-shaped portion 113 deforms to movably movement-restrict, abut against and fit to a corresponding structure of the body portion 12. The variable portion 115 is of lesser rigidity than the tool d. In this embodiment, the corresponding structure is a joining portion 123 disposed at one end of the body portion 12. Hence, the head portion 11 is movably fitted to the body portion 12.

The head-shaped portion 113 is a raised element, dented element, planar element, cylindrical element, rod element, lever element, arcuate element, curved element, stepped element, slope element, cap element, engaging element, thread element, outer engaging element, inner engaging element or resilient engaging element. The axial portion 114 is a cylindrical element, raised element, dented element, hole element, slot element, fitting element, engaging element or resilient element. Therefore, the present disclosure meets the need for high industrial applicability.

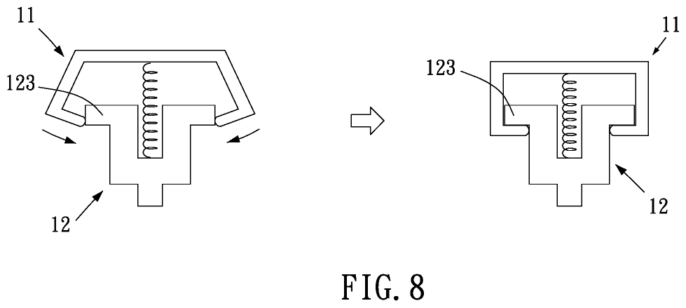

Referring to FIG. 8, in this embodiment, the head portion 11 is a resilient engaging element capable of resilient engagement to abut against the corresponding structure of the body portion 12, then expand, and finally engage with the corresponding structure of the body portion 12. In this embodiment, the corresponding structure is a joining portion 123 disposed at one end of the body portion 12. Therefore, the head portion 11 can engage with the joining portion 123; hence, the head portion 11 is movably fitted to the body portion 12.

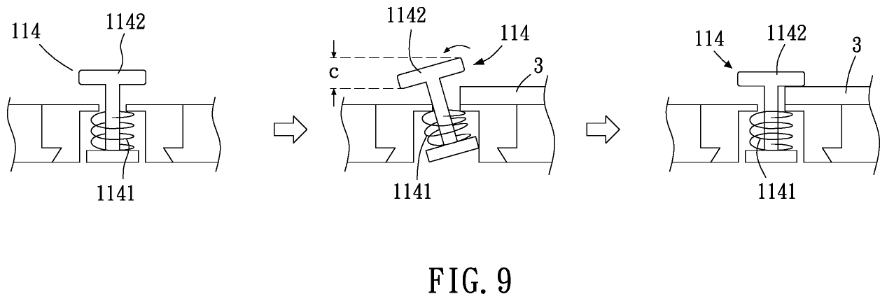

Referring to FIG. 9, in this embodiment, the axial portion 114 comprises a resilient component 1141 and a head portion 1142. The resilient component 1141 fits around the axial portion 114. Therefore, the axial portion 114 undergoes displacement because of its rotational buoyancy level c relative to the body portion 12, thereby achieving the required engagement of the head portion 1142 and the second object 3.

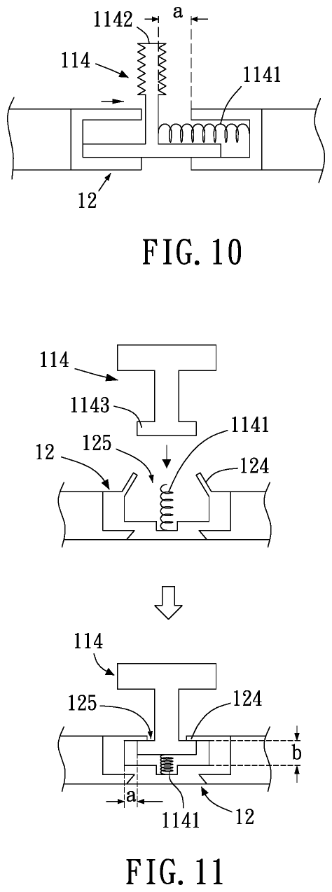

Referring to FIG. 10, in this embodiment, the axial portion 114 comprises the resilient component 1141 and the head portion 1142. The resilient component 1141 abuts against the body portion 12 and the axial portion 114. Therefore, the axial portion 114 undergoes displacement because of its lateral buoyancy level a relative to the body portion 12, so as to achieve the required engagement using the head portion 1142.

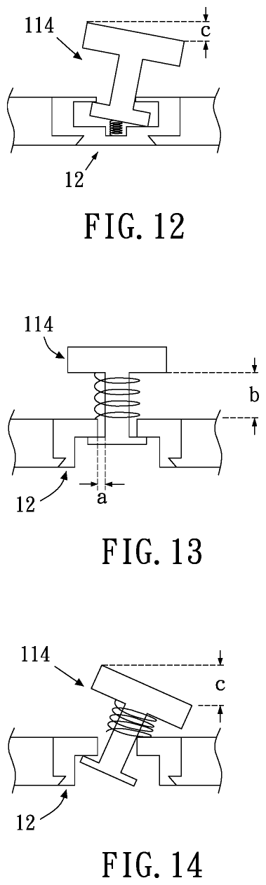

Referring to FIG. 11 and FIG. 12, in this embodiment, the body portion 12 has a variable portion 124. The variable portion 124 is an upward-protruding element or downward-protruding element which has a hole portion 125. The variable portion 124 is compressed under an applied force as soon as the corresponding structure of the axial portion 114 passes through the hole portion 125. Therefore, the variable portion 124 deforms, and in consequence the hole portion 125 of the variable portion 124 is smaller than the corresponding structure of the axial portion 114; hence, the variable portion 124 abuts against and restricts movement of the corresponding structure of the axial portion 114, and thus the variable portion 124 is movably fitted to the axial portion 114 to allow the axial portion 114 to undergo displacement because of its lateral buoyancy level a, vertical buoyancy level b or rotational buoyancy level c relative to the body portion 12, thereby achieving the required engagement. The variable portion 124 is of lesser rigidity than a die which exerts an applied force on the variable portion 1124. In this embodiment, the corresponding structure is a stopping portion 1143 disposed at one end of the axial portion 114.

Referring to FIG. 13 and FIG. 14, in this embodiment, the body portion 12 is variable in shape and is movably fitted to the axial portion 114, and in consequence the axial portion 114 undergoes displacement because of its lateral buoyancy level a, vertical buoyancy level b or rotational buoyancy level c relative to the body portion 12, thereby achieving the required engagement.

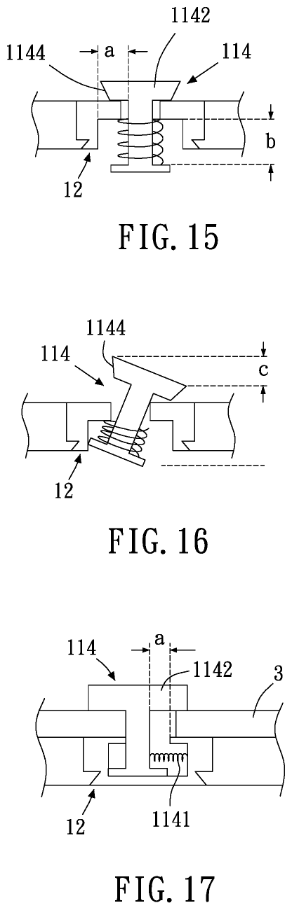

Referring to FIG. 15 and FIG. 16, in this embodiment, the head portion 1142 of the axial portion 114 has a guiding portion 1144. The axial portion 114 is movably fitted to the body portion 12, and in consequence the axial portion 114 undergoes displacement because of its lateral buoyancy level a, vertical buoyancy level b or rotational buoyancy level c relative to the body portion 12, allowing the head portion 1142 to achieve the required engagement through the guiding portion 1144.

Referring to FIG. 17, in this embodiment, the axial portion 114 comprises the resilient component 1141 and the head portion 1142. The resilient component 1141 abuts against the body portion 12 and the axial portion 114 and is disposed therebetween. Therefore, the axial portion 114 undergoes displacement because of its lateral buoyancy level a relative to the body portion 12, so as to achieve the required engagement of the head portion 1142 and the second object 3.

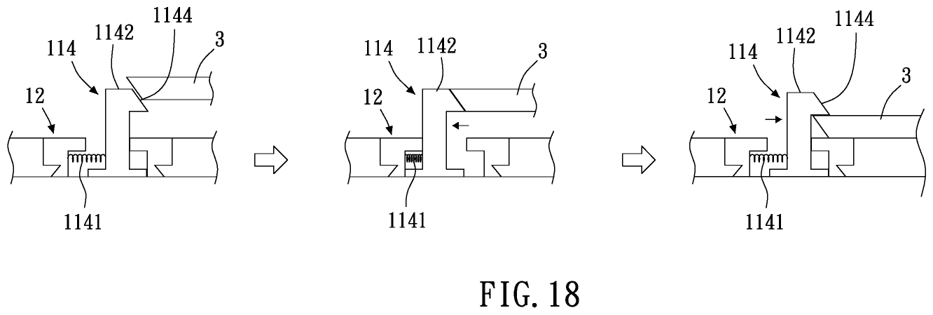

Referring to FIG. 18, in this embodiment, the head portion 1142 of the axial portion 114 has a guiding portion 1144, and the second object 3 abuts against the guiding portion 1144 to therefore push the axial portion 114. Furthermore, the axial portion 114 compresses the resilient component 1141. After the second object 3 has passed through the head portion, the axial portion 114 moves toward the second object 3 under the resilient restoring force exerted by the resilient component 1141, allowing the head portion 1142 to engage with the second object 3.

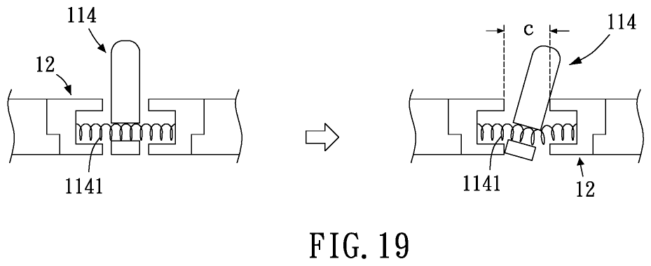

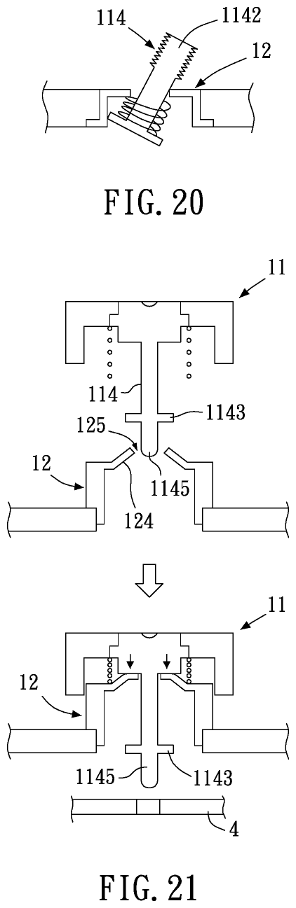

Referring to FIG. 19 and FIG. 20, in this embodiment, the axial portion 114 is a cylindrical element, whereas the resilient component 1141 passes through the axial portion 114, and two ends of the resilient component 1141 abut against the body portion 12. Therefore, the axial portion 114 has rotational buoyancy level c. Furthermore, the head portion 1142 of the axial portion 114 is a thread element (shown in FIG. 20).

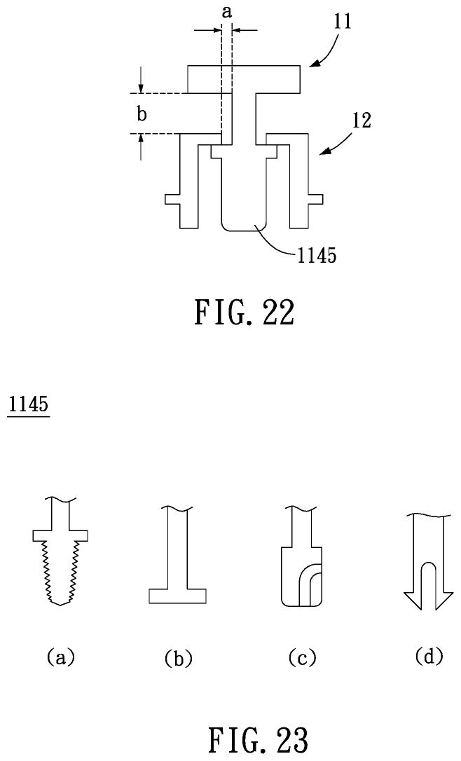

Referring to FIG. 21 through FIG. 23, in this embodiment, the body portion 12 has a variable portion 124. The variable portion 124 is an upward-protruding element with a hole portion 125. After the axial portion 114 has passed through the hole portion 125, the head portion 11 presses against the variable portion 124 such that the variable portion 124 deforms; hence, the hole portion 125 of the variable portion 124 is smaller than the stopping portion 1143 of the axial portion 114 to thereby abut against and restrict movement of the axial portion 114, so as to not only allow the body portion 12 to be movably fitted to the head portion 11, but also achieve the required engagement because of lateral buoyancy level a and vertical buoyancy level b between the head portion 11 and the body portion 12.

In this embodiment, the axial portion 114 has an engaging portion 1145. The engaging portion 1145 is a cylindrical element. Owing to its lateral buoyancy level a and vertical buoyancy level b relative to the body portion 12, the head portion 11 enables the engaging portion 1145 to engage with a third object 4. In a variant embodiment, the engaging portion 1145 is a thread element (part a of FIG. 23), outer engaging element (part b of FIG. 23), inner engaging element (part c of FIG. 23), resilient engaging element (part d of FIG. 23), raised engaging element, hook element, dented element or raised element.

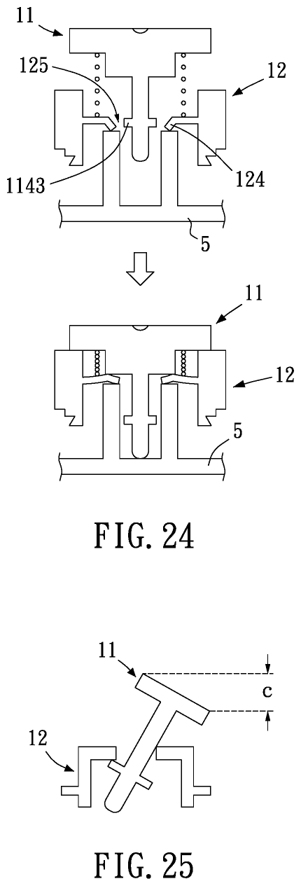

Referring to FIG. 24 and FIG. 25, in this embodiment, the body portion 12 has a variable portion 124. The variable portion 124 is a downward-protruding element with a hole portion 125. An assembly process entails placing the body portion 12 in a die 5 and then abutting the variable portion 124 of the body portion 12 against the die 5 to allow the head portion 11 and the die 5 to press against the variable portion 124 as soon as the axial portion 114 passes through the hole portion 125, so as for the variable portion 124 to deform, so as to abut and movement-restrict the stopping portion 1143 of the axial portion 114, so as to movably fit together the head portion 11 and the body portion 12, thereby allowing the head portion 11 to undergo displacement because of its lateral, rotational buoyancy level c relative to the body portion 12, so as to achieve the required engagement.

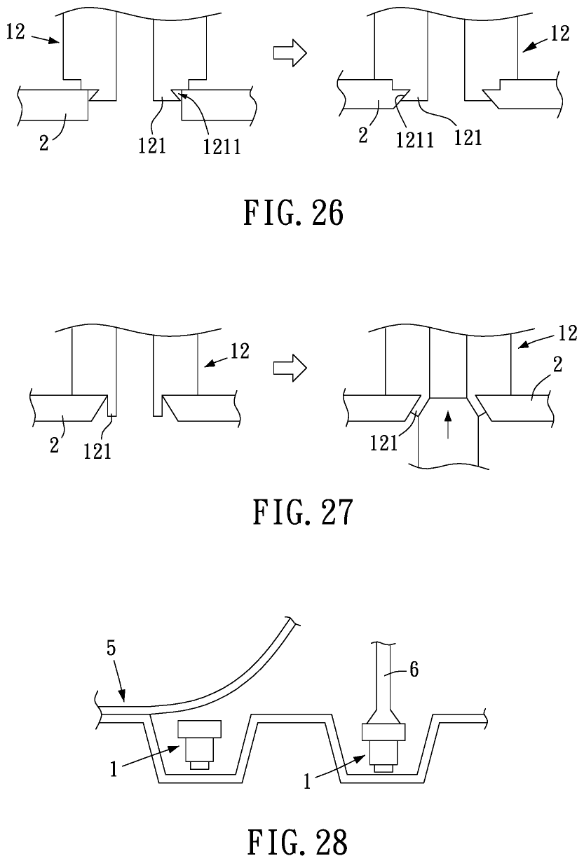

Referring to FIG. 26, in this embodiment, the body portion 12 is of greater rigidity than the first object 2, and the fitting portion 121 has a material-storing space 1211. Therefore, as soon as the body portion 12 presses against the first object 2, the material of the first object 2 is subjected to pressure and thus enters or flows into the material-storing space 1211, allowing the body portion 12 to be fitted to the first object 2.

Referring to FIG. 27, in this embodiment, the fitting portion 121 is subjected to compression under an applied force and thus deforms and engages with the first object 2, allowing the body portion 12 to be fitted to the first object 2.

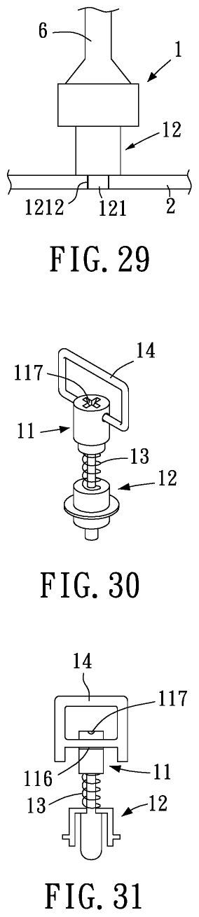

Referring to FIG. 28, FIG. 29, FIG. 48 and FIG. 49, in this embodiment, the control device 1 is carried by a carrier 5 and taken out of the carrier 5 with a tool 6. After that, a comparison device 8 figures out an assembling location of the control device 1 at the first object 2, or figures out the precise location of the control device 1 relative to the first object 2. Next, the tool 6 places the control device 1 precisely at a target location of the first object 2 (PCB), so as to fit the control device 1 to the first object 2. In this embodiment, the fitting portion 121 has a weldable surface 1212 adapted to be placed on the surface of the first object 2 and then heated up such that the body portion 12 can be welded to the first object 2. The weldable surface 1212 is made of tin, nickel, zinc, copper or chromium. The tool 6 is a vacuum suction tool for vacuum suctioning the control device 1. The comparison device 8 is a visual comparison device or image comparison device.

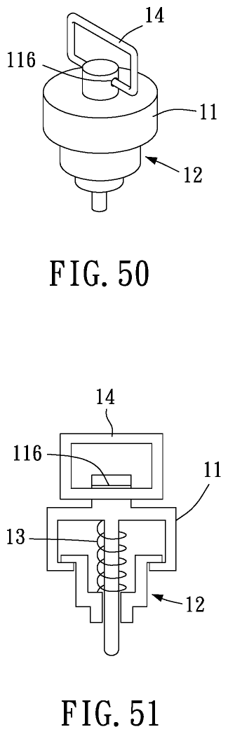

Referring to FIG. 30, FIG. 31, FIG. 50 and FIG. 51, in this embodiment, the head portion 11 has a pulling portion 14 for pulling the control device. The head portion 11 has a through hole 116 (or a slot portion) conducive to the positioning of the pulling portion 14. The head portion 11 has an operating portion 117 for facilitating the operation of another tool. The head portion 11 and the body portion 12 in FIG. 50 and FIG. 51 differ from the head portion 11 and the body portion 12 in FIG. 30 and FIG. 31 in terms of shape. As shown in FIG. 50 and FIG. 51, the resilient component 13 fits around the axial portion 114 and is disposed in the head portion 11 and the body portion 12, whereas two ends of the resilient component 13 abut against the head portion 11 and the body portion 12, respectively.

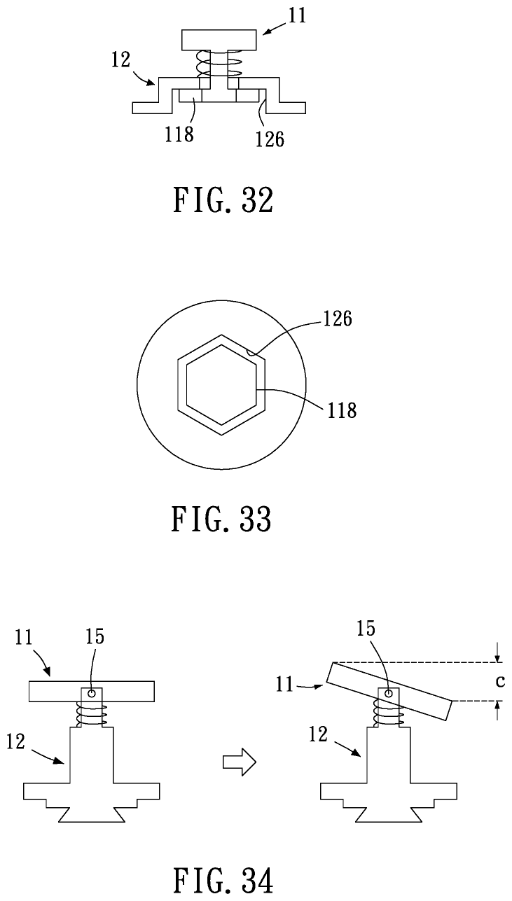

Referring to FIG. 32 and FIG. 33, in this embodiment, the body portion 12 has a rotation-preventing portion 126, whereas the head portion 11 has a corresponding rotation-preventing portion 118, to prevent or restrict rotation and movement of the body portion 12 and the head portion 11 relative to each other. The body portion 12 has a limiting portion, whereas the head portion 11 has a corresponding limiting portion (not shown), to prevent or restrict rotation and movement of the body portion 12 and the head portion 11 relative to each other.

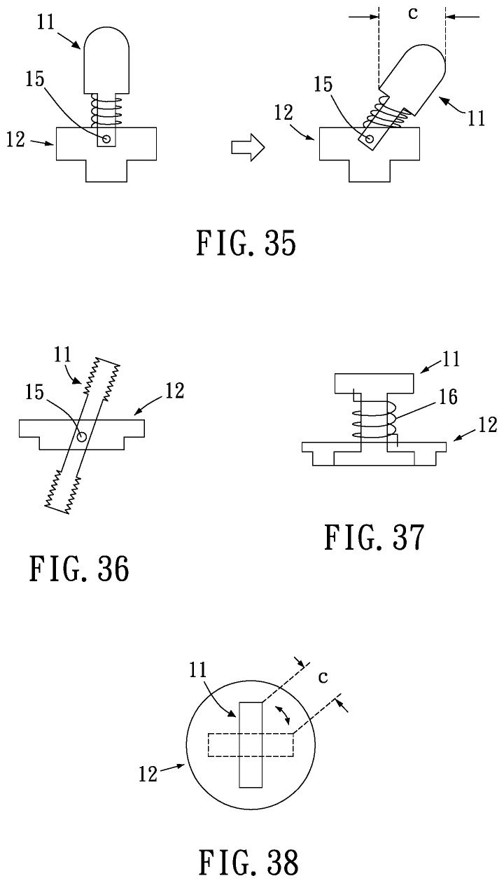

Referring to FIG. 34 through FIG. 36, in this embodiment, the body portion 11 and the head portion 12 are pivotally connected and fitted to each other by a pivotally connecting portion 15. Owing to the pivotally connecting portion 15, the head portion 11 has rotational buoyancy level c relative to the body portion 12, and thus the head portion 11 attains the required engagement. FIG. 34 through FIG. 36 show that the head portion 11 is of different shapes and the body portion 12 is of different shapes but are pivotally connected and fitted to each other by the pivotally connecting portion 15.

Referring to FIG. 37 and FIG. 38, in this embodiment, forward or lateral rotational buoyancy displacement occurs between the body portion 12 and the head portion 11, whereas disposed between the head portion 11 and the body portion 12 is a torsional spring 16 with two ends abutting against (or twisting) the head portion 11 and the body portion 12, respectively, such that the head portion 11 is capable of resilient reversing or resilient restoring, or stays at an abutted position as a result of the torsional spring 16 normally abutting against the head portion 11. Therefore, after the head portion 11 has rotated relative to the body portion 12 because of rotational buoyancy level c therebetween, the torsional spring 16 restores the head portion 11 to its original position.

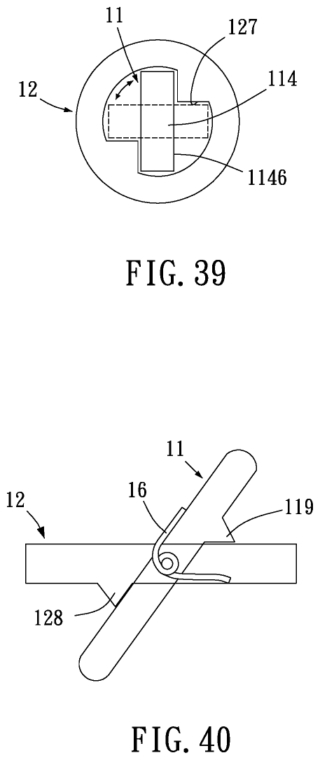

Referring to FIG. 39, in this embodiment, the body portion 12 has a limiting portion 127, whereas the head portion 11 has the axial portion 114 (or cap portion). The axial portion 114 has a corresponding limiting portion 1146. Forward or lateral rotational buoyancy displacement occurs between the body portion 12 and the head portion 12. The limiting portion 127 and the corresponding limiting portion 1146 together restrict rotational buoyancy displacement of the head portion 11.

Referring to FIG. 40, in this embodiment, the head portion 11 and the body portion 12 have restricting portions 119, 128, respectively, for restricting lateral buoyancy level a, vertical buoyancy level b or rotational buoyancy level c of the head portion 11. Two ends of the torsional spring 16 abut against the head portion 11 and the body portion 12, respectively, such that the head portion 11 is capable of resilient reversing or resilient restoring, or stays at an abutted position as a result of the torsional spring normally abutting against the head portion 11.

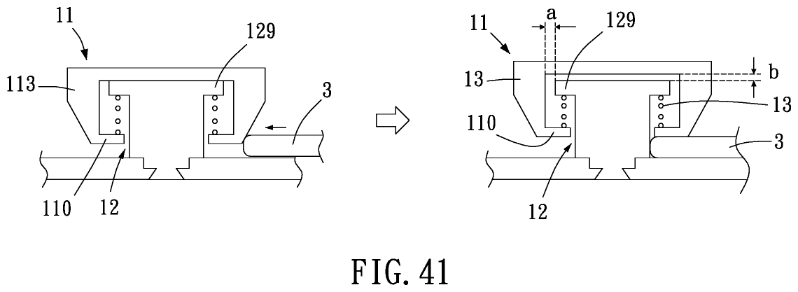

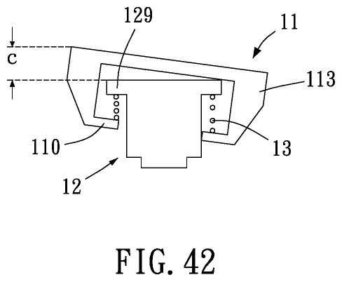

Referring to FIG. 41 through FIG. 43, in this embodiment, the body portion 12 has a limiting portion 129. The head portion 11 has a corresponding limiting portion 110. In this embodiment, the corresponding limiting portion 110 is disposed at the head-shaped portion 113. The limiting portion 129 and the corresponding limiting portion 110 stop each other and thereby prevent each other from moving relative to each other. The resilient component 13 is disposed between the limiting portion 129 and the corresponding limiting portion 110 and adapted to abut against the head portion 11 and the body portion 12 and thereby cause the head portion 11 and the body portion 12 to undergo a lateral, vertical or rotational movement, or a restoring movement performed after motion and intended to restore to a pre-motion position. Owing to lateral buoyancy level a, vertical buoyancy level b or rotational buoyancy level c between the head portion 11 and the body portion 12, the head portion 11 can engage with the second object 3.

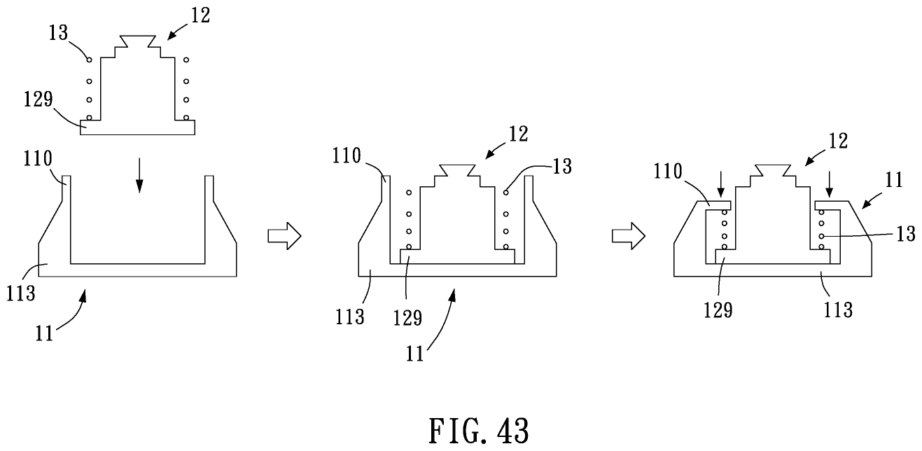

The assembly process (shown in FIG. 43) entails placing the body portion 12 in the head-shaped portion 113, then fitting the resilient component 13 around the body portion 12, and finally exerting an applied force on the corresponding limiting portion 110. Therefore, the head portion 11 is movably fitted to the body portion 12, and thus the resilient component 13 is disposed between the limiting portion 129 and the corresponding limiting portion 110.

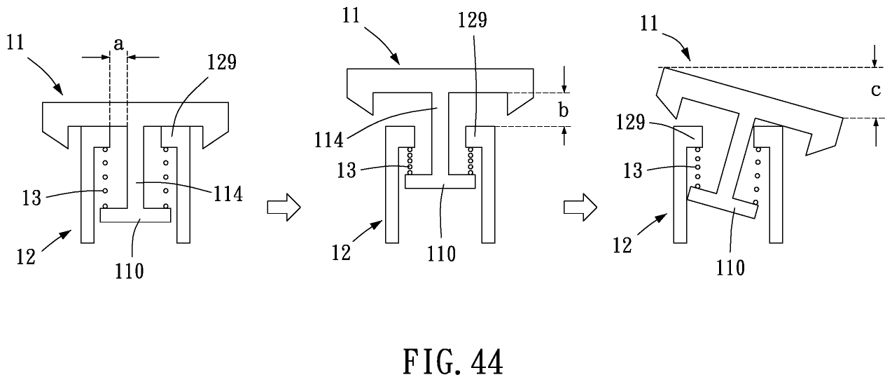

Referring to FIG. 44, in this embodiment, the head portion 11 has the axial portion 114 and the corresponding limiting portion 110. In this embodiment, the corresponding limiting portion 110 is disposed at the axial portion 114. The body portion 12 has the limiting portion 129. The resilient component 13 is disposed between the limiting portion 129 and the corresponding limiting portion 110 and adapted to abut against the head portion 11 and the body portion 12 and thereby cause the head portion 11 and the body portion 12 to undergo a lateral, vertical or rotational movement, or a restoring movement performed after motion and intended to restore to a pre-motion position. Owing to lateral buoyancy level a, vertical buoyancy level b or rotational buoyancy level c between the head portion 11 and the body portion 12, the head portion 11 can achieve the required engagement.

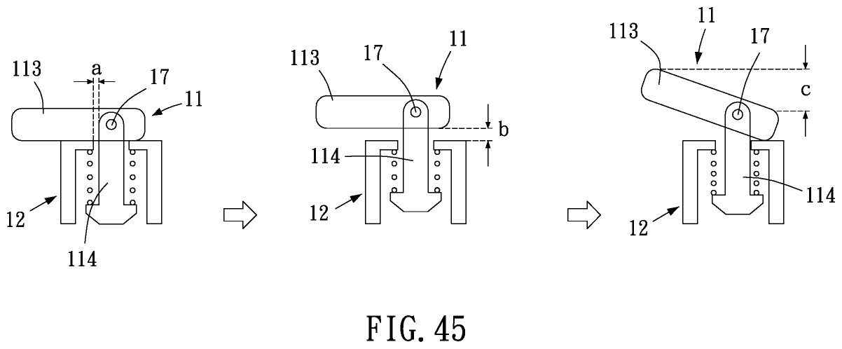

Referring to FIG. 45, in this embodiment, the head-shaped portion 113 and the axial portion 114 are pivotally connected and thereby fitted to each other. In this embodiment, the head-shaped portion 113 and the axial portion are movably pivotally connected and fitted to each other by a pivotal connecting element 17 such that the head portion 11 can achieve the required engagement because of lateral buoyancy level a, vertical buoyancy level b or rotational buoyancy level c between the head portion 11 and the body portion 12. The pivotal connecting element 17 is a cylindrical element or engaging element and is integrally formed with the head-shaped portion 113 or the axial portion 114.

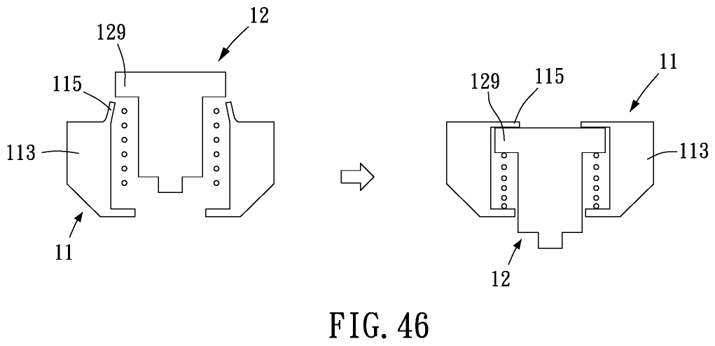

Referring to FIG. 46, in this embodiment, the head-shaped portion 113 has a variable portion 115. During the assembly process, a force is applied to the variable portion 115 to cause its deformation such that the head-shaped portion 113 movably movement-restricts and abuts against the limiting portion 129 of the body portion 12. Therefore, the head portion 11 is movably fitted to the body portion 12.

In conclusion, embodiments of the present disclosure provide a control device with a body portion and a head portion. The body portion of the control device can be fitted to a body portion of a first object. The head portion of the control device engages or removes the second object. Hence, the control device can couple together two objects and separate the two objects, performing the coupling and separating processes repeatedly and rapidly.

While the present disclosure has been described by means of specific embodiments, numerous modifications and variations could be made thereto by those skilled in the art without departing from the scope and spirit of the present disclosure set forth in the claims.

What is claimed is:

1. A control device, comprising:
a head portion; and
a body portion movably fitted to the head portion, wherein lateral buoyancy level, vertical buoyancy level or rotational buoyancy level between the head portion and the body portion enables shifting, tightening, restrictive abutment or rotational abutment between the head portion and the body portion.

2. The control device of claim 1, wherein a resilient component is disposed between the head portion and the body portion and adapted to abut against the head portion or the body portion and thereby cause the head portion or the body portion to undergo a lateral, vertical or rotational movement, or a restoring movement performed after motion and intended to restore to a pre-motion position.

3. The control device of claim 1, wherein the head portion has a head-shaped portion or an axial portion such that the head-shaped portion or the axial portion is movably fitted to the body portion.

4. The control device of claim 3, wherein the head-shaped portion has a variable portion and thereby is deformable under an applied force such that the head-shaped portion movably restricts movement of, abuts against and is fitted to a corresponding structure of the body portion.

5. The control device of claim 3, wherein the body portion has a variable portion deformable under an applied force to therefore abut against and restrict movement of a corresponding structure of the axial portion or a corresponding structure of the head-shaped portion so as to be movably fitted to the head portion.

6. The control device of claim 2, wherein the resilient component laterally, vertically, or rotationally abuts against the head portion or the body portion.

7. The control device of claim 2, wherein the head portion or the body portion has therein a receiving space for receiving the resilient component.

8. The control device of claim 1, wherein the head portion has a guiding portion for guiding a second object to become disposed between the head portion and the body portion by engagement or snap-engagement and thereby movement-restricted, or to be movement-restricted by the head portion.

9. The control device of claim 3, wherein the axial portion comprises the resilient component and the head portion.

10. The control device of claim 5, wherein the variable portion of the body portion is an upward-protruding element or a downward-protruding element with a hole portion such that, as soon as a corresponding structure of the axial portion passes through the hole portion and thus is subjected to pressure under an applied force, the hole portion of the variable portion is smaller than the corresponding structure of the axial portion, thereby allowing the body portion to be movably fitted to the head portion.

11. The control device of claim 1, wherein the head portion is a resilient engaging element capable of resilient engagement and adapted to abut against a corresponding structure of the body portion, then expand, and finally engage with the corresponding structure of the body portion.

12. The control device of claim 2, wherein the fitting portion has a material-storing space such that, as soon as the body portion presses against the first object, material of the first object is subjected to pressure and thus enters or flows into the material-storing space, thereby allowing the body portion to be fitted to the first object.

13. The control device of claim 2, wherein the fitting portion is subjected to compression under an applied force and thus deforms and engages with the first object, thereby allowing the body portion to be fitted to the first object.

14. The control device of claim 2, wherein the fitting portion has a weldable surface adapted to be placed on the surface of the first object and then heated up such that the body portion can be welded to the first object.

15. The control device of claim 1, wherein the control device is carried by a carrier and taken out of the carrier with a tool before being placed on the first object, so as to fit the control device to the first object.

16. The control device of claim 1, wherein the head portion has a pulling portion for pulling the control device.

17. The control device of claim 16, wherein the head portion has a through hole or a slot portion conducive to positioning the pulling portion in place.

18. The control device of claim 1, wherein the body portion has a rotation-preventing portion or a limiting portion, and the head portion has a corresponding rotation-preventing portion or a corresponding limiting portion, to prevent or restrict rotation and movement relative to each other.

19. The control device of claim 1, wherein the body portion and the head portion are pivotally connected and fitted to each other by a pivotally connecting portion.

20. The control device of claim 1, wherein the body portion has a limiting portion, the head portion has an axial portion or a cap portion, the axial portion or the cap portion has a corresponding limiting portion for restricting rotational buoyancy displacement of the head portion.

21. The control device of claim 1, wherein forward or lateral rotational buoyancy displacement occurs between the body portion and the head portion.

22. The control device of claim 1, further comprising a torsional spring with two ends abutting against or twisting the head portion and the body portion, respectively, such that the head portion is capable of resilient reversing or resilient restoring or stays at an abutted position as a result of the torsional spring normally abutting against the head portion.

23. The control device of claim 1, wherein the head portion or the body portion has a restricting portion for restricting lateral buoyancy level, vertical buoyancy level or rotational buoyancy level of the head portion.

24. The control device of claim 3, wherein the head-shaped portion and the axial portion are pivotally connected and thereby fitted to each other.

25. The control device of claim 1, wherein the rotational buoyancy level is defined as a variation in an angle between the head portion and the body portion to thereby vary a distance between different positions thereof, wherein the distance resulting from the angular variation equals a difference in the distance variation between different parts of the head portion or equals a difference in the distance variation between different parts of the head portion and different parts of the body portion.

26. The control device of claim 1, wherein the body portion has a limiting portion, and the head portion has a corresponding limiting portion, such that the limiting portion and the corresponding limiting portion stop each other and thereby prevent each other from moving relative to each other.

27. The control device of claim 26, wherein a resilient component is disposed between the limiting portion and the corresponding limiting portion and adapted to abut against and thereby cause the head portion or the body portion to undergo a lateral, vertical or rotational movement, or a restoring movement performed after motion and intended to restore to a pre-motion position.

28. The control device of claim 15, wherein the control device is configured to be carried by a carrier and taken out of the carrier with a tool, and a comparison device figures out an assembling location of the control device at the first object, the tool places the control device at the first object, so as to fit the control device to the first object.

29. The control device of claim 3, wherein the axial portion is a cylindrical element, raised element, dented element, hole element, slot element, fitting element, engaging element or resilient element.

30. The control device of claim 1, wherein a rustproof layer is disposed on the surface of the body portion or the head portion, the rustproof layer is configured to be formed by placing the head portion or the body portion in an electroplating chamber, and passing electric current to an electroplating solution in the electroplating chamber such that the head portion or the body portion is covered with a rustproof substance through the electroplating solution to form the rustproof layer.
